(19) United States
(12) Patent Application Publication
(10) Pub. No.: US 2019/0052711 A1
(43) Pub. Date: Feb. 14, 2019

(54) SYSTEM AND METHOD FOR PEER-TO-PEER CONNECTIVITY

(71) Applicant: MOREGA SYSTEMS INC., Toronto (CA)

(72) Inventors: Vadzim KHARLANAU, Mississauga (CA); Joel ANDERSON, North York (CA); Thomas Walter MAXWELL, Stromberg (DE)

(21) Appl. No.: 15/674,004

(22) Filed: Aug. 10, 2017

(51) Int. Cl. H04L 29/08

(52) U.S. Cl. CPC H04L 67/141; H04L 61/2589; H04L 67/148; H04L 67/1061

(57) ABSTRACT

A method in a mobile client device includes: establishing a plurality of connections with a fixed device; selecting, from the plurality of connections, a primary connection and a secondary connection distinct from the primary connection; storing, in a memory: (i) primary connection parameters defining the primary connection; and (ii) secondary connection parameters defining the secondary connection; initiating a data transfer session with the fixed device over the primary connection; and, responsive to detecting a reduction in link quality associated with the primary connection, sending a request to continue the data transfer session over the secondary connection.

### FIELD

The specification relates generally to peer-to-peer communications, and specifically to a system and method for peer-to-peer connectivity.

### BACKGROUND

The establishment of peer-to-peer connections is frequently complicated by the presence of one or more network address translators (NATs) between the peer devices. Various mechanisms have been developed to establish peer-to-peer connections despite the obstacles presented by NATs. However, such mechanisms may increase the time required to establish connections, and may also be vulnerable to changes in network conditions.

### SUMMARY

An aspect of the specification provides a method in a mobile client device, comprising: establishing a plurality of connections with a fixed device; selecting, from the plurality of connections, a primary connection and a secondary connection distinct from the primary connection; storing, in a memory: (i) primary connection parameters defining the primary connection; and (ii) secondary connection parameters defining the secondary connection; initiating a data transfer session with the fixed device over the primary connection; and, responsive to detecting a reduction in link quality associated with the primary connection, sending a request to continue the data transfer session over the secondary connection.

### BRIEF DESCRIPTIONS OF THE DRAWINGS

Embodiments are described with reference to the following figures, in which:

FIG. 1 depicts a communications system;

FIG. 2 depicts certain internal components of the mobile device and the fixed device of the system of FIG. 1;

FIG. 3 depicts a method establishing and maintaining peer-to-peer connectivity;

FIGS. 4-6 depict the communications system of FIG. 1 during the performance of the method of FIG. 3; and

FIG. 7 depicts an example architecture of a connectivity management application in the fixed device and the mobile device of FIG. 1.

### DETAILED DESCRIPTION

Peer-to-peer connections may be established between, for example, a fixed media server such as a set-top-box or home computer, and a mobile device such as a smartphone, tablet computer or the like. The media server may then be configured to serve (e.g. via a media stream over the peer-to-peer connection) media or other data to the mobile device. The peer-to-peer connection, however, typically must traverse one or more NAT devices, such as home routers, routers operated by Internet Service Providers (ISPs), and the like. The media server and the mobile device may not be aware of the existence of each NAT device between them.

Conventional approaches to establishing peer-to-peer connections in the presence of NAT devices include protocols such as Interactive Connectivity Establishment (ICE), as described in the Internet Engineering Task Force (IETF) RFC 5245, incorporated herein by reference. The ICE protocol requires the peers to identify and exchange candidate addressing information, and to evaluate a plurality of connections employing the candidate addressing information. Having evaluated the connections, the peer devices select a connection to use.

The above approaches are complicated when one of the peers is mobile. When the mobile device, for example, travels between distinct networks, each change in networking environment may result in the peer-to-peer connection dropping. Loss of the connection typically requires a repetition of the ICE process outlined above, and data exchange (such as the above-mentioned media streaming) between the peers may not be possible until the ICE process is complete.

In addition, data exchanges such as media streaming are typically implemented with the User Datagram Protocol (UDP). The use of UDP may negatively impact the reliability of the connection between peers; however, attempts to improve reliability (e.g. by implementing Transmission Control Protocol (TCP) connections, or TCP-like features for the peer-to-peer connection may introduce undesirable latency to the peer-to-peer connection.

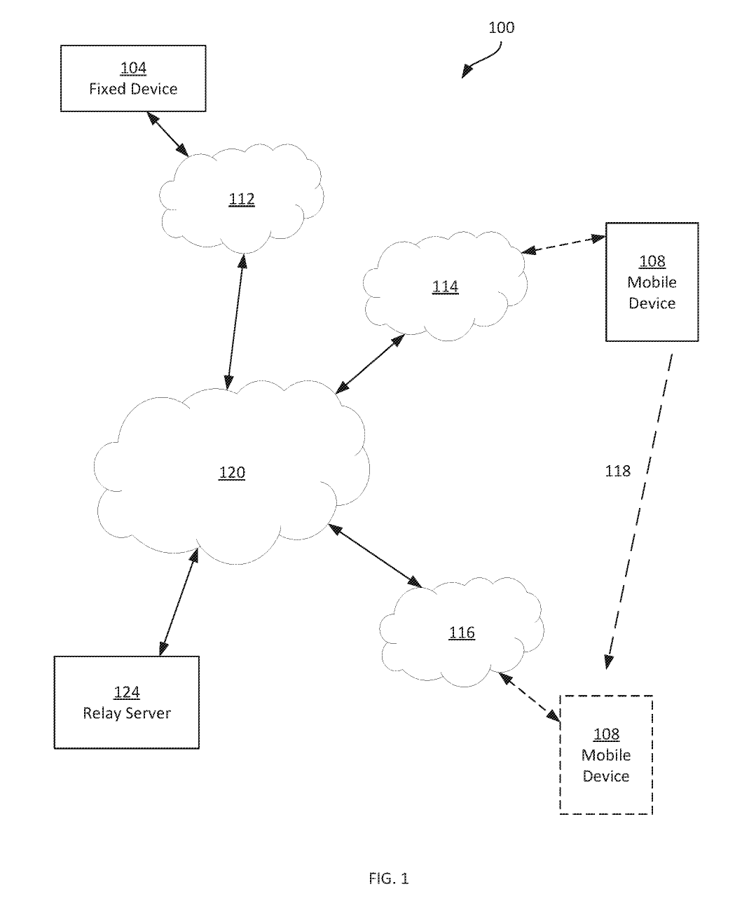

Referring to FIG. 1, a communications system 100 is illustrated. The system 100 includes at least two peer devices. In the present example, a fixed peer device 104, such as a set-top box (STB), digital video record (DVR) or any other suitable home-based media server, is provided. The system 100 also includes a mobile peer device 108, such as a smartphone, a tablet computer, or the like. In general, the fixed device 104, although not necessarily entirely immobile, remains in sufficient physical proximity to a first network 112 to remain consistently connected with the network 112. The network 112 is, in the present example, a local area network, such as a wireless (e.g. WiFi) network, a wired network, or a combination thereof.

The mobile device 108, in contrast with the fixed device 104, typically travels with an operator of the mobile device 108. The mobile device 108 can therefore connect to a variety of networks, including a second network 114 when the mobile device 108 is in a physical location illustrated in solid lines, and a third network 116 when the mobile device 108 is in a different physical location, illustrated in dashed lines (e.g., when the mobile device 108 travels along a path 118 between the above-mentioned locations). As will be apparent, the mobile device 108 can also travel between a wide variety of other networks beyond those shown in FIG. 1. The networks 114 and 116 are typically wireless networks (that is, the connection between the mobile device 108 and access points implementing the networks 114, 116 is typically wireless), though they may also be wired networks or combinations of wired and wireless networks. As will now be apparent, the networks 114 can include local-area networks, cellular networks, and the like.

The fixed device 104 and the mobile device 108 are configured to establish peer-to-peer connections, as will be described below in greater detail. Each of the networks 112, 114, 116 are connected to a wide-area network (WAN) 120 such as the Internet. Accordingly, as will now be apparent, the above-mentioned peer-to-peer connections traverse the network elements implementing the network 112, as well as those implementing the network 120, and those implementing the one of the networks 114 and 116 to which the mobile device 108 is currently connected. As will also be apparent, a peer-to-peer connection may be broken due to the physical movements of the mobile device 108 (e.g. the device 108 may move out of range of the network 114).

Further, the system 100 includes a relay server 124 connected to the network 120. The relay server 124, in the present example, is implemented as a Traversal Using Relays around NAT (TURN) server. The relay server 124 is therefore configured, in this example, to establish a relay connection between the devices 104 and 108, via the network 120, according the IETF RFC 5766, incorporated herein by reference. For example, the relay server 124 can be configured to exchange messages with the devices 104 and 108 formatted according to the Session Traversal Utilities for NAT (STUN) protocol (see IETF RFC 5389, incorporated herein by reference). The relay server 124 may, however, also be implemented according to any other suitable relay specifications. In general, as will be discussed below in greater detail, the relay server 124 permits the devices 104 and 108 to establish a relay connection with each other traversing the relay server 124. The devices 104 and 108 are configured to store, e.g. in memory, a network address or other identifier for connecting with the relay server 124 via the network 120.

The devices 104 and 108 are configured, in addition to establishing the above-mentioned relay connection, to establish and evaluate a one or more other connections and to establish peer-to-peer communications based on the results of such an evaluation. Further, the devices 104 and 108 are configured to perform certain actions to maintain or re-establish the peer-to-peer communications in the event of a interruption (e.g., caused by physical movement of the device 108 from the network 114 to the network 116).

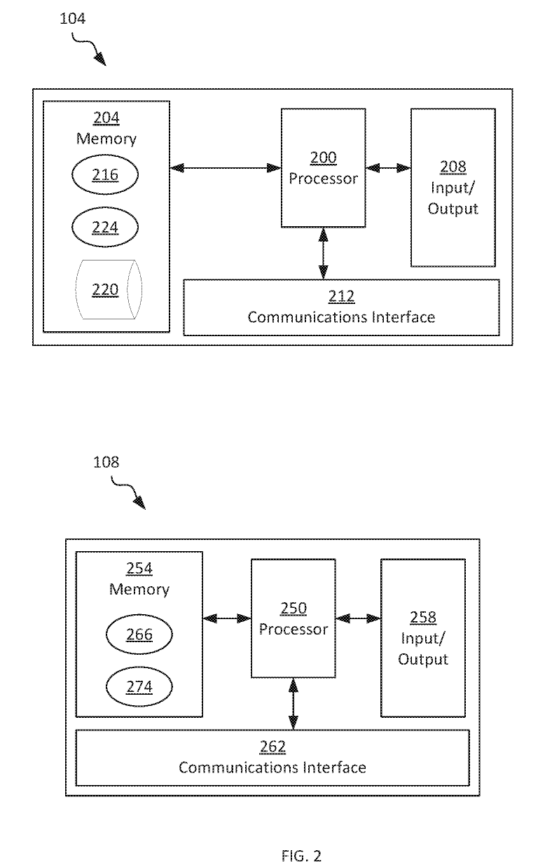

Before discussing the functions implemented by the devices 104 and 108 to establish and maintain peer-to-peer connectivity in greater detail, certain internal components of the devices 104 and 108 will be described, with reference to FIG. 2. As seen in FIG. 2, the device 104 includes a central processing unit (CPU), also referred to as a processor 200. The processor 200 is interconnected with a non-transitory computer readable storage medium, such as a memory 204, having stored thereon various computer readable instructions for performing various actions (e.g. receiving and responding to requests from the device 108 for streaming media). The memory 200 includes a suitable combination of volatile (e.g. Random Access Memory or RAM) and non-volatile memory (e.g. read only memory or ROM, Electrically Erasable Programmable Read Only Memory or EEPROM, flash memory). The processor 200 and the memory 204 each comprise one or more integrated circuits.

The device 104 also includes one or more input devices, and one or more output devices, generally indicated as an input/output device 208. The input and output devices 208 serve to receive commands for controlling the operation of the device 104 and for presenting information, e.g. to a user of the device 104. The input and output devices 208 therefore include any suitable combination of devices, including a keyboard, a mouse, a display, a touchscreen, a speaker, a microphone, and the like).

The device 104 further includes a communications interface 212 interconnected with the processor 200. The communications interface 212 enables the device 104 to communicate with other computing devices. More specifically, the communications assembly 212 includes any suitable combination of hardware elements (e.g. controllers, radio assemblies and the like) enabling the device 104 to communicate over the network 112.

The computer readable instructions stored in the memory 204 for execution by the processor 200 include, for example, a media streaming application 216 configured to retrieve media (e.g. video data, image data, audio data, and the like) from a repository 220 stored in the memory 204, and transmit the media to the mobile device 108 responsive to requests from the mobile device 108. As will be apparent, execution of the application 216 may also configure the fixed device 104 to perform functions other than the delivery of media data to the mobile device 108.

In addition to the application 216, the device 104 stores in the memory 204, for execution by the processor 200, a connectivity management application 224. As will be discussed in greater detail below, the connectivity management application 224 (also referred to simply as the application 224) is configured to establish and maintain connectivity between the devices 104 and 108.

The mobile device 108 includes a central processing unit (CPU), also referred to as a processor 250. The processor 250 is interconnected with a non-transitory computer readable storage medium, such as a memory 254, having stored thereon various computer readable instructions for performing various actions (e.g. requesting streaming media from the device 104, and receiving and presenting the streaming media upon receipt from the device 104). The memory 254 includes a suitable combination of volatile (e.g. Random Access Memory or RAM) and non-volatile memory (e.g. read only memory or ROM, Electrically Erasable Programmable Read Only Memory or EEPROM, flash memory). The processor 250 and the memory 254 each comprise one or more integrated circuits.

The device 108 also includes one or more input devices, and one or more output devices, generally indicated as an input/output device 258. The input and output devices 258 serve to receive commands for controlling the operation of the device 108 and for presenting information (such as the above-mentioned streaming media), e.g. to a user of the device 108. The input and output devices 258 therefore include any suitable combination of devices, including a display, a touchscreen, a speaker, a microphone, and the like).

The device 108 further includes a communications interface 262 interconnected with the processor 250. The communications interface 262 enables the device 108 to communicate with other computing devices. More specifically, the communications assembly 262 includes any suitable combination of hardware elements (e.g. controllers, radio assemblies and the like) enabling the device 108 to communicate over the networks 114 and 116, as well as any of a variety of other networks. The communications interface 262 may, for example, include at least one cellular radio and at least one WiFi radio.

The computer readable instructions stored in the memory 254 for execution by the processor 250 include, for example, a media streaming application 266 configured to request and receive media data from the fixed device 104, and to present the media (e.g. via the display and speakers mentioned above) upon receipt from the device 104. As will be apparent, execution of the application 266 may also configure the mobile device 108 to perform functions other than the request and receipt of media data from the fixed device 104.

In addition to the application 266, the device 108 stores in the memory 254, for execution by the processor 250, a connectivity management application 274. As will be discussed in greater detail below, the connectivity management application 274 (also referred to simply as the application 274) is configured to establish and maintain connectivity between the devices 104 and 108.

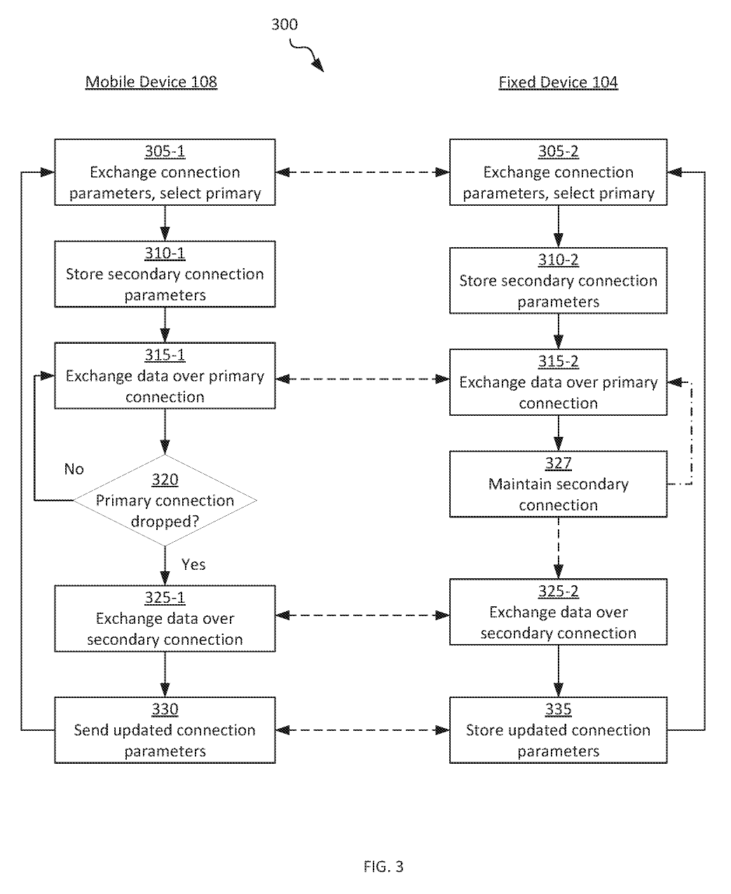

Turning now to FIG. 3, a method 300 of establishing and maintaining peer-to-peer connectivity is illustrated. The method 300 will be described in conjunction with its performance by the system 100. In particular, as indicated in FIG. 3, certain blocks of the method 300 are performed by the mobile device 108 (via the execution of the applications 266 and 274 by the processor 250), while other blocks of the method 300 are performed by the fixed device 104 (via execution of the applications 216 and 224 by the processor 200).

At blocks 305-1 and 305-2, the mobile device 108 and the fixed device 104, respectively, are configured to discover and exchange connection parameters, and to evaluate the connection parameters in order to select a primary connection over which to initiate peer-to-peer data transfer (e.g., streaming media delivery from the device 104 to the device 108). The discovery and exchange of connection parameters, as well as the selection of a primary connection, may be conducted according to the ICE process mentioned earlier. In brief, the device 104 is configured to determine a plurality of candidate connection parameter sets. Each set includes one or more IP addresses, ports, and the like with which the device 104 can be reached via the network 112, from a point outside the network 112. Likewise, the device 108 is configured to determine a plurality of sets of candidate connection parameters. Each set includes one or more IP addresses, ports, and the like with which the device 108 can be reached via the network 114, from a point outside the network 114. The devices 104 and 108 are then configured to exchange the above-mentioned connection parameters with each other, for example via a session initiation protocol (SIP) relay server, an Extensible Messaging and Presence Protocol (XMPP) relay server (not shown), or the like.

Each pair of candidate connection parameter sets (i.e. one set corresponding to the device 104, and one set corresponding to the device 108) defines a path through the networks shown in FIG. 1 over which a connection may be established between the devices 104 and 108. One of the pairs of connection parameter sets defines a connection via the relay server 124, rather than a peer-to-peer connection.

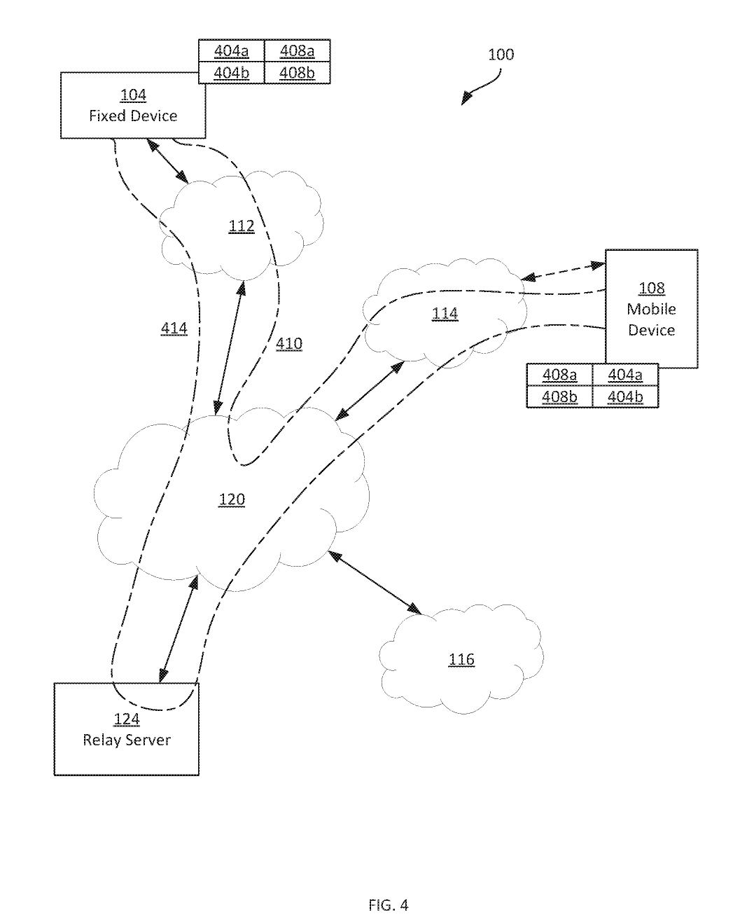

FIG. 4 illustrates the system 100, following the exchange of connection parameter sets by the devices 104 and 108. In particular, each device stores two pairs of connection parameter sets. A first pair includes connection parameter sets 404a (defining addressing information for the device 104) and 408a (defining addressing information for the device 108), and a second pair includes connection parameter sets 404b (defining alternative addressing information for the device 104) and 408b (defining alternative addressing information for the device 108). The “a” sets correspond to a peer-to-peer connection 410 via the networks 112, 114 and 120, and the “b” sets correspond to a relay connection 414 via the relay server 124. As will be apparent, additional pairs of connection parameter sets may also be exchanged and stored at the devices 104 and 108 in other examples.

Returning to FIG. 3, to complete the performance of block 305-1 and 305-2, the devices 104 and 108 are configured to establish each of the connections defined by the connection parameter sets exchanged, and to select one of the connections as a primary connection, based on one of more predefined criteria. The criteria can include any suitable one of, or combination of, the bandwidth available over a connection, the latency imposed by a connection, the time required to establish the connection, and the like. In the present example performance of the method 300, it is assumed that the connection 410 is selected as the primary connection at blocks 305.

At blocks 310-1 and 310-2, each device 104, 108 is configured, in addition to the connection parameters for the selected primary connection, to store the connection parameters for at least one secondary connection. In some examples, all connection parameters exchanged at blocks 305 are stored by the devices 104 and 108. In general, at least one secondary connection is stored. In the present example, the secondary connection is a relay connection via the relay server 124.

At blocks 315-1 and 315-2, the devices 104 and 108 are configured to exchange data over the primary connection selected at blocks 305-1 and 305-2. In the present example performance of the method 300, therefore, at blocks 315, the devices 104 and 108 are configured to exchange data (e.g., streaming media) over the peer-to-peer connection 410 defined by the connection parameter sets 404a and 404b.

At block 320, the mobile device 108 is configured to determine whether the primary connection—the connection 410, in the present example—has dropped or degraded beyond one or more predefined thresholds. For example, the mobile device 108 can be configured to monitor link bandwidth, latency and the like, and to compare those attributes to predefined thresholds stored in the memory 254. When the monitored attributes fail to meet the thresholds (or when the connection is simply lost), the determination at block 320 is affirmative, and the performance of the method 300 proceeds to block 325. When the determination is negative, however, the exchange of data over the primary connection 410 continues at blocks 315.

Simultaneously with the exchange of data over the connection 410 and the monitoring of connection health by the mobile device 108 at block 320, at block 327 the fixed device 104 is configured to maintain the secondary connection (that is the connection via the relay server 124) at block 327. In some examples, the fixed device 104 is configured to send periodic keep-alive messages to the relay server 124 via the networks 112 and 120 to maintain the connection established at block 305-1 and 305-2 via the relay server 124. For example, in establishing the connection 414 the fixed device 104 can be configured to send a request to the relay server to establish a data channel for delivery of data to the mobile device 108. As will be apparent to those skilled in the art, in establishing the data channel, the relay server 124 stores the addressing information of the mobile device 108 in association with a data channel identifier. To send data to the mobile device 108 via the connection 414, the fixed device 104 need only include the data channel identifier (e.g., in a header), rather than the complete addressing information of the mobile device 108. The relay server 124 is configured to discard inactive data channels, and the fixed device 104 is therefore configured, at block 327, to send keep-alive messages to the relay server 124 when data channels are employed.

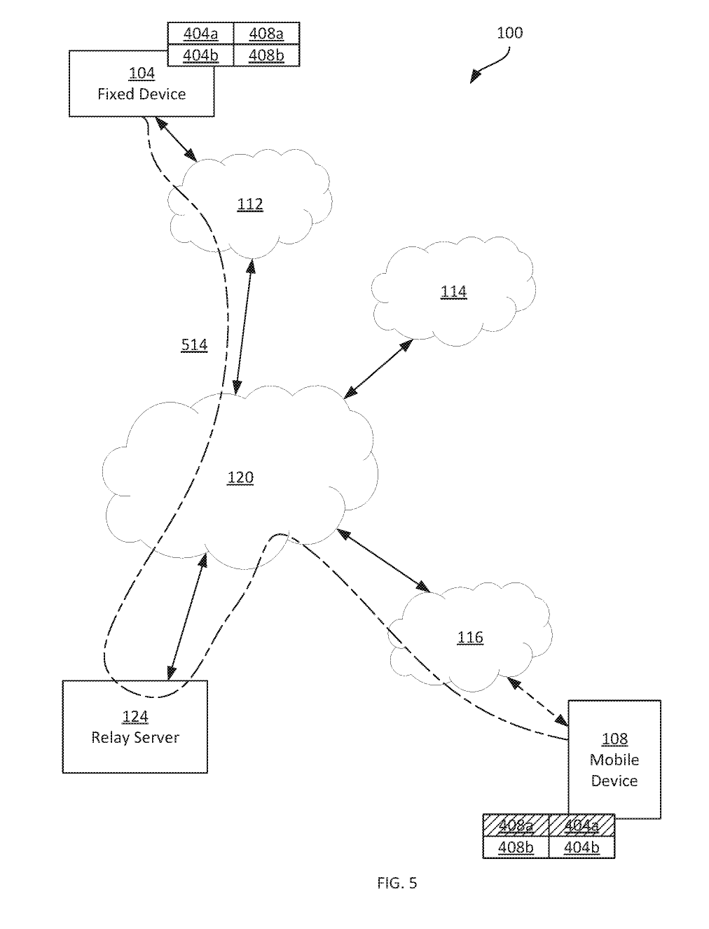

At block 325-1, following a determination that the primary connection has dropped or degraded to a predefined degree, the mobile device 108 is configured to initiate a transition of the data exchange from the primary connection 410 to the secondary connection 414. Turning to FIG. 5, the mobile device 108 is illustrated as having moved out of range of the network 114 and into range with the network 116. As a result, the mobile device 108 has dropped the connection with the network 114, and the primary connection 410 shown in FIG. 4, selected at block 305, cannot be maintained. The “a” connection parameter sets may be deleted by the device 108, as they are no longer valid.

To initiate the transition to data exchange over the secondary connection via the relay server 124, the mobile device 108 is configured to transmit a request to the relay server 124 via the network 116, including an identifier associated with the fixed device 104. For example, the identifier may be a connection identifier assigned to the connection 414 and therefore associated with the devices 104 and 108 at the relay server 124. The request is therefore a request to re-establish the connection 414 between the fixed device 104 and the new location of the mobile device 108.

The relay server 124 is configured, in contrast with some conventional relay servers, to accept communications from any mobile device (including the mobile device 108) that are directed to the fixed device 104. Therefore, although the addressing information associated with the mobile device 108 has changed, rather than refusing the request sent by the mobile device 108 at block 325-1, as conventional relay servers (e.g., TURN servers) are typically configured to do, the relay server 124 is configured to receive the request and transmit the request to the fixed device 104. The fixed device 104, in turn, is configured to receive the request and may perform one or more security checks, as discussed further below. When the security checks pass (or are simply omitted), the fixed device 104 is configured to initiate communications with the mobile device 108. Communications may be initiated by the fixed device 104 by sending data to the relay server 124 (e.g. formatted as STUN messages) for delivery to the mobile device 108 at the current addressing information for the mobile device 108 (e.g. as defined by the parameters 408b). In other examples, in which the above-mentioned data channels are employed between the fixed device 104 and the relay server 124, the fixed device 104 may initiate communications with the mobile device 108 by requesting establishment of a new data channel, associated with the current addressing information of the mobile device 108, at the relay server. In either of the above implementations, communications are established over a connection 514 between the fixed device 104 and the mobile device 108 via the relay server 124, as shown in FIG. 5.

In the present example, as noted above, before accepting communications from the mobile device 108 over the connection 514, the fixed device 104 is configured to perform one or more security checks. For example, before completing establishment of the leg of the connection 514 between the fixed device 104 and the relay server 124, the fixed device 104 can be configured to determine whether communications are still being carried over the connection 414 (i.e., if the mobile device 108 is in fact still connected via the network 114 rather than the network 116). If such a determination is affirmative, establishment of the connection 514 may be refused by the fixed device 104, as the newly established connection 514 may be a malicious attack by a party other than the mobile device 108. For example, the fixed device 104 may abort the sending of a request to establish a new data channel to complete the connection 514 as discussed above. The fixed device 104 may also be configured to compare the above-mentioned connection identifier as received in the request from the mobile device 108 to the connection identifier stored in association with the connection 414. If the connection identifiers do not match, the fixed device 104 may be configured to refuse the request (i.e., to refuse the establishment of the connection 514).

As noted earlier, when a data channel is employed between the fixed device 104 and the relay server 124 to deliver data to the mobile device 108, the fixed device 104 is configured to keep the data channel between the relay server 124 and the fixed device 104 alive, for example via the transmission of keep-alive messages. When the fixed device 104 requests the establishment of a new data channel to complete the connection 514, the fixed device 104 is configured to cease sending keep-alive messages to maintain the data channel associated with the connection 414 shown in FIG. 4, and to begin sending keep-alive messages to maintain the data channel for the connection 514. Thus, the connection 414 will time-out, as the relay server 124 is typically configured to terminate data channels for connections that have been inactive for a predetermined time period (e.g., ten minutes). The connection 514 will therefore, in the present example, coexist with the connection 414 until expiry of the timeout period associated with the data channel for the connection 414. At block 325-1 and 325-2, the mobile device 108 and the fixed device 104 therefore resume the exchange of data initiated at blocks 315-1 and 315-2, employing the secondary connection 514 rather than the now-defunct primary connection 410.

At block 330, the mobile device 108 is configured to discover updated connection parameter sets, for example via the ICE discovery process mentioned earlier. The mobile device 108 is further configured to send the updated connection parameter sets to the fixed device 104. The updated connection parameter sets can be sent to the fixed device 104 via the above-mentioned SIP relay, XMPP relay, or the like. In the present example performance of the method 300, however, the mobile device 108 is configured to send the updated connection parameter sets to the fixed device 104 over the secondary connection 514 itself. In the present example, in which the relay server 124 is a modified TURN server, the mobile device 108 is configured to transmit the updated connection parameters to the relay server 124 as raw data (e.g., UDP-formatted data), and the relay server 124 is configured to repackage the updated connection parameters for transmission to the fixed device 104, for example in one or more fields of a STUN message or over the above-mentioned data channel, when the data channel is employed.

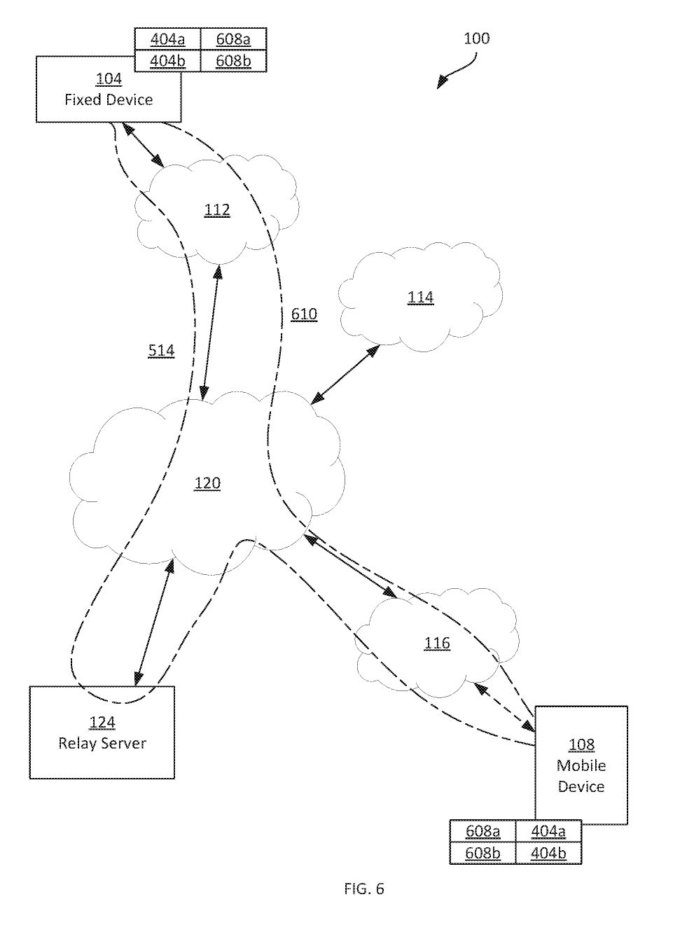

Upon receipt of the updated connection parameter sets from the mobile device 108, at block 335 the fixed device 104 is configured to initiate a further performance of block 305-2, to evaluate the connections defined by the updated connection parameter sets. Referring to FIG. 6, updated connection parameter sets 608a and 608b are illustrated following the transmission at block 330 (and the receipt and storage of the update parameters at block 335). In particular, in addition to the relay connection 514 (for which the connection parameters corresponding to the mobile device 108 have been refreshed), a peer-to-peer connection 610 is defined by the connection parameter sets 404a and 608a. In other examples, the connection parameter set 404a is also replaced with a new connection parameter set (e.g., 404c, not shown), reflecting the newly established data channel between the relay server 124 and the fixed device 104 for carrying data between the fixed device 104 and the mobile device 108. The replacement connection parameter set reflects the new data channel. As a result, in such examples the fixed device 104 also transmits updated connection parameters to the mobile device 108 at block 335. Through a further performance of blocks 305-1 and 305-2, the devices 104 and 108 are configured to evaluate the connections 514 and 610, and to select one of those connections as the primary connection. The data exchange can then continue over the newly selected primary connection.

The discovery and transmission of updated connection parameters at block 330 may also be performed by the mobile device 108 in the absence of a determination at block 320 that the primary connection has dropped or degraded. For example, the mobile device 108 can be configured to periodically repeat the discovery and transmission of connection parameters to the fixed device 104. Responsive to such discovery and transmission (e.g. over the relay connections 414 or 514), the devices 104 and 108 can re-evaluate the available connections at blocks 305, simultaneously with data exchange at blocks 315 or 325, and determine whether to select a new primary connection.

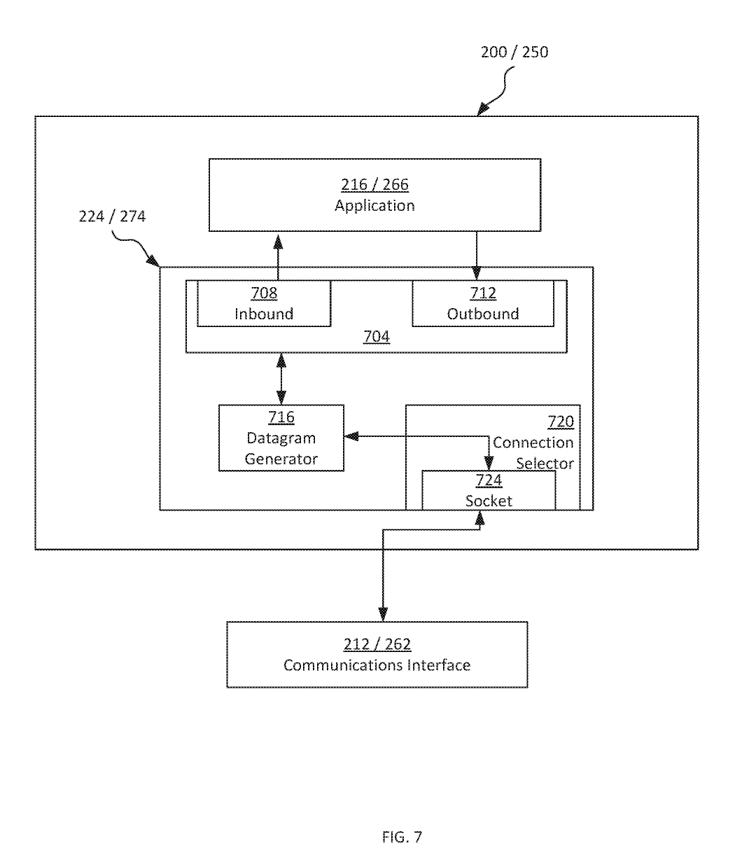

Turning to FIG. 7, an example implementation of the applications 224 and 274 is depicted, the execution of which configures the devices 104 and 108 to perform the blocks of the method 300 as described above. The application components illustrated in FIG. 7 may be deployed at both of the devices 104 and 108. As will be apparent to those skilled in the art, although the components of the applications 224 and 274 are illustrated as being stored in the memories 204 and 254 of the devices 104 and 108, and as being executed by the processors 200 and 250, in other examples the components discussed below may instead by implemented on dedicated hardware elements, such as one or more application-specific integrated circuits (ASICs).

The applications 224 and 274 each include a virtual channel manager 704, configured to expose an inbound socket 708 and an outbound socket 712 for the media streaming applications 216 and 266 to receive and send data, respectively during the performances of blocks 315 and 325. For example, at the mobile device 108, the application 266 is configured to pass requests addressed to the device 104 to the outbound socket 712, and to receive streaming media from the inbound socket 708.

The virtual channel manager 704 is also configured, in some examples, to multiplex distinct types of service requests (e.g., from the application 266) and service data (e.g., from the application 216), as well as to demultiplex service requests (e.g., for delivery to the application 216) and data (e.g., for delivery to the application 266). For example, the application 266 may be configured to request both a television stream from the device 104, and a television guide overlay from the device 104. The virtual channel manager 704 at the device 108 is configured, in such examples, to receive a stream request and a guide request from the application 266. The virtual channel manager 704 is further configured to combine the two above-mentioned requests into a single request, including a header field indicating the types and positions of the requests. The virtual channel manager 704 at the device 104, in turn, is configured to demultiplex the requests for provision to the application 216, based on the above-mentioned header.

The applications 224 and 274 also include a datagram generator 716 configured to both receive outbound data from the virtual channel manager and generate one or more datagrams for transmission at blocks 315 and 325 of the method 300, and receive datagrams and extract the data therefrom for provision to the virtual channel manager 704. In the present example, the datagram generator 716 is configured to generate UDP datagrams, e.g. based on the QUIC protocol. In other examples, the datagram generator 716 is configured to implement any suitable datagram generation protocol. Of particular note, however—and in contrast to conventional implementations of the QUIC protocol—the datagram generator 716 is not responsible for datagram socket control. Instead, each application 224 and 274 includes a connection selector 720, configured to maintain connection parameter sets, select primary connections, and initiate data transfer via secondary connections. In other words, the selector 720 is configured to perform blocks 305, 310, 320, 330 and 335 of the method 300. The datagram generator 716 is configured to provide outbound datagrams to the connection selector for transmission via a datagram socket 724 maintained by the selector 720 (and defined by the connection parameters 404, 408, 608 discussed earlier). Similarly, the selector 720 is configured to receive datagrams via the socket 724.

The scope of the claims should not be limited by the embodiments set forth in the above examples, but should be given the broadest interpretation consistent with the description as a whole.

1. A method in a mobile client device, comprising:
establishing a plurality of connections with a fixed device;
selecting, from the plurality of connections, a primary connection and a secondary connection distinct from the primary connection;
storing, in a memory:
(i) primary connection parameters defining the primary connection; and
(ii) secondary connection parameters defining the secondary connection;
initiating a data transfer session with the fixed device over the primary connection; and
responsive to detecting a reduction in link quality associated with the primary connection, sending a request to continue the data transfer session over the secondary connection.

2. The method of claim 1, wherein establishing the second connection comprises establishing the second connection via a relay server.

3. The method of claim 2, further comprising, during the data transfer session, sending periodic keep-alive messages to the relay server.

4. The method of claim 1, further comprising:
responsive to sending the request, discovering updated connection parameters for the mobile device; and
transmitting the updated connection parameters to the fixed device.

5. The method of claim 4, further comprising transmitting the updated connection parameters via the secondary connection.

6. The method of claim 5, further comprising transmitting the updated connection parameters in a control message.

7. The method of claim 4, further comprising: receiving further connection parameters from the fixed device.

8. The method of claim 7, further comprising:
repeating the establishing the selecting, and the storing based on the updated connection parameters and the further connection parameters.

9. A mobile device, comprising
a communications interface;
a memory; and
a processor interconnected with the memory, the processor configured to:
establish a plurality of connections with a fixed device;
select, from the plurality of connections, a primary connection and a secondary connection distinct from the primary connection;
store, in the memory:
(i) primary connection parameters defining the primary connection; and
(ii) secondary connection parameters defining the secondary connection; and
initiate a data transfer session with the fixed device over the primary connection; and
responsive to detecting a reduction in link quality associated with the primary connection, send a request to continue the data transfer session over the secondary connection.

10. The method of claim 9, wherein establishing the second connection comprises establishing the second connection via a relay server.

11. The method of claim 10, the processor further configured, during the data transfer session, to send periodic keep-alive messages to the relay server.

12. The method of claim 9, the processor further configured to:
responsive to sending the request, discover updated connection parameters for the mobile device; and
transmit the updated connection parameters to the fixed device.

13. The method of claim 12, the processor further configured to transmit the updated connection parameters via the secondary connection.

14. The method of claim 13, the processor further configured to transmit the updated connection parameters in a control message.

15. The method of claim 12, the processor further configured to: receive further connection parameters from the fixed device.

16. The method of claim 15, the processor further configured to:
repeat the establishing the selecting, and the storing based on the updated connection parameters and the further connection parameters.
